(19) United States
(12) Patent Application Publication
(10) Pub. No.: US 2024/0328868 A1
(43) Pub. Date: Oct. 3, 2024

(54) METHOD FOR AVERAGING SEAWATER TEMPERATURES

(71) Applicant: S&R PROJECT LLC, Tokyo (JP)

(72) Inventor: Fujio MURAMATSU, Tokyo (JP)

(73) Assignee: S&R PROJECT LLC, Tokyo (JP)

(21) Appl. No.: 18/129,131

(22) Filed: Mar. 31, 2023

(51) Int. Cl. G01K 3/06; G01K 13/02

(52) U.S. Cl. CPC G01K 3/06; G01K 13/026; A01G 15/00

(57) ABSTRACT

A sea-surface temperature lowering apparatus effectively lowers the temperature of seawater near a sea surface to allow low-temperature deep seawater pumped to around the sea surface to stay close to the sea surface without sinking immediately. The sea-surface temperature lowering apparatus includes a pump that pumps deep seawater. The pumped deep seawater and surface water are agitated to generate agitated water. The sea-surface temperature lowering apparatus includes a platform including the pump and an agitation device. The deep seawater with a low temperature and the surface water with a high temperature are mixed to generate the agitated water. This lowers the temperature of seawater near the sea surface without the deep seawater sinking immediately.

### BACKGROUND

### Technical Field

The present invention relates to a method for averaging seawater temperatures for controlling hurricane occurrence.

### Description of the Background

Patent Literature 1 describes a method for disrupting a generated tropical cyclone, including introducing a chemical to the eye wall of the tropical cyclone. Patent Literature 2 describes a method for diminishing the ability of clouds to turn into rain by dispersing cross-linked polymers in rain clouds and causing the polymers to absorb rain.

### CITATION LIST

### Patent Literature

Patent Literature 1: U.S. Pat. No. 5,441,200
Patent Literature 2: U.S. Pat. No. 6,315,213

### BRIEF SUMMARY

When deep seawater is pumped toward a sea surface, high-density deep seawater that is heavier than low-density seawater near the sea surface can sink into the deep sea.

One or more aspects of the present invention are directed to an apparatus and a method for lowering the temperature of sea surface water to allow low-temperature deep seawater pumped to around the sea surface to stay close to the sea surface without sinking immediately.

A sea-surface temperature lowering apparatus according to a first aspect of the present invention includes a pump that pumps deep seawater, an agitation device that agitates the deep seawater and surface water to generate a density current, and a platform including the agitation device. The generated density current is discharged to join the Gulf Stream toward the mainland of the United States to reduce water vapor generation along a track of a tropical cyclone and reduce a hurricane on the mainland of the United States.

A sea-surface temperature lowering apparatus according to a second aspect of the present invention is the sea-surface temperature lowering apparatus according to the first aspect further including a gas injection device that injects a gas into the density current.

A sea-surface temperature lowering apparatus according to a third aspect of the present invention is the sea-surface temperature lowering apparatus according to the second aspect, in which the gas injection device injects the gas into the density current to generate a dissolved-oxygen density current with a higher concentration of oxygen. The dissolved-oxygen density current is generated in the platform installed at a reference position with the coordinates of 20°00′00″ north latitude and 13°44′31″ west longitude, and is discharged into a sea area with a radius of 100 to 1,000 km.

A sea-surface temperature lowering apparatus according to a fourth aspect of the present invention is the sea-surface temperature lowering apparatus according to the second aspect, in which the gas injection device is located downstream in the density current from an agitator included in the agitation device.

A sea-surface temperature lowering apparatus according to a fifth aspect of the present invention is the sea-surface temperature lowering apparatus according to the fourth aspect, in which the platform includes a density current channel, in which the density current flows, and the agitator is located upstream from the gas injection device in the density current channel.

A sea-surface temperature lowering apparatus according to a sixth aspect of the present invention is the sea-surface temperature lowering apparatus according to the second aspect, in which the gas injection device injects the gas into seawater in an agitator included in the injection device or seawater flowing into the agitator.

A sea-surface temperature lowering apparatus according to a seventh aspect of the present invention is the sea-surface temperature lowering apparatus according to the second aspect, in which the gas injected into the density current includes microbubbles with a diameter of 1 to 50 μm inclusive, or nanobubbles with a diameter less than 1 μm.

A sea-surface temperature lowering apparatus according to an eighth aspect of the present invention is the sea-surface temperature lowering apparatus according to the first aspect further including composite blades including pumping blades in the pump and introduction blades in the agitation device. The pumping blades and the introduction blades are integral with each other. The composite blades are fixed to a single rotational shaft.

A sea-surface temperature lowering method according to a ninth aspect of the present invention includes generating mixed water being a density current by agitating deep seawater pumped and surface water in the surface water, and discharging the generated density current toward an ocean current flowing around United States coasts to reduce a hurricane on the East Coast of the United States.

A sea-surface temperature lowering method according to a tenth aspect of the present invention is the sea-surface temperature lowering method according to the ninth aspect, in which the discharging the generated density current includes discharging a dissolved-oxygen density current from a predetermined circular area including a center position with coordinates of 20°00′00″ north latitude and 13°44′31″ west longitude toward the Gulf Stream to control occurrence of a hurricane on the East Coast of the United States.

A sea-surface temperature lowering method according to an eleventh aspect of the present invention is the sea-surface temperature lowering method according to the ninth aspect further including injecting a gas into the mixed water.

A sea-surface temperature lowering method according to a twelfth aspect of the present invention is the sea-surface temperature lowering method according to the eleventh aspect, in which the injecting the gas includes injecting the gas into seawater before the deep seawater and the surface water are agitated.

A sea-surface temperature lowering method according to a thirteenth aspect of the present invention is the sea-surface temperature lowering method according to the eleventh aspect, in which the injecting the gas includes injecting the gas into the density current after the deep seawater and the surface water are agitated.

The apparatus and the method according to the above aspects effectively lower the temperature of seawater near the sea surface to allow low-temperature deep seawater pumped to around the sea surface to stay close to the sea surface without sinking immediately.

### BRIEF DESCRIPTION OF DRAWINGS

FIG. 1 is a schematic diagram of a sea-surface temperature lowering apparatus according to a first embodiment of the present invention.

FIGS. 2A to 2B are photographs and a diagram of a large impeller usable in the sea-surface temperature lowering apparatus according to the first embodiment.

FIG. 3 is a schematic diagram of an example gas injection device in the first embodiment.

FIG. 4 is a schematic diagram of an apparatus according to a second embodiment of the present invention illustrating its main components.

FIG. 5 is a schematic diagram of an apparatus according to a third embodiment of the present invention illustrating its main components.

FIG. 6 is a diagram of hurricanes and tropical cyclones in the North Atlantic Ocean (1851 to 2013) and the Northeast Pacific Ocean (1949 to 2013) illustrating their tracks.

### DETAILED DESCRIPTION

A sea-surface temperature lowering apparatus according to a first embodiment will now be described.

### First Embodiment

A sea-surface temperature lowering apparatus 1 according to the first embodiment includes a platform 40 installed on the ocean, a pump 3 for pumping deep seawater 4, and an agitation device 7 for agitating the pumped deep seawater 4 and surface water 5 to generate mixed water 6 as a density current 6 (denoted with the same reference numeral as the mixed water).

The deep seawater 4 is typically seawater in a deep-sea area deeper than or equal to 200 m below the sea surface. However, the deep seawater 4 herein includes low-temperature seawater that can reduce water vapor generation.

The platform 40 herein includes a base 2. The base 2 in the platform 40 includes a part stationary on the sea surface and another part movable on the sea. The platform 40 includes an energy source for generating energy to power the pump 3 and the agitation device 7, and a communication device 8. The energy source includes an internal combustion engine.

The agitation device 7 at least includes an agitator 13 for agitating the surface water 5 and the deep seawater 4, and introduction blades 11 to draw seawater near a sea surface 50 into the agitator 13.

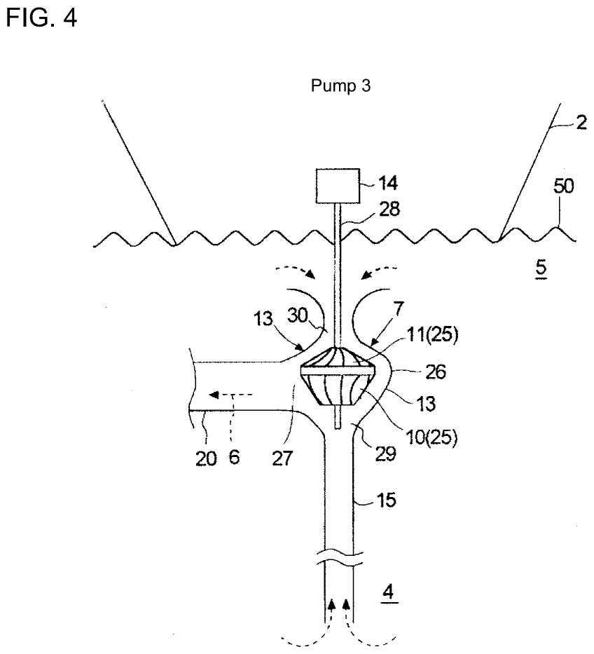

The pump 3 typically includes components such as a motor 14 (refer to, for example, FIG. 4) to rotate pumping blades 10 (pumping impeller), the pumping blades 10, and an agitation-pumping pipe 15 through which the deep seawater 4 is pumped toward the sea surface 50 for agitation.

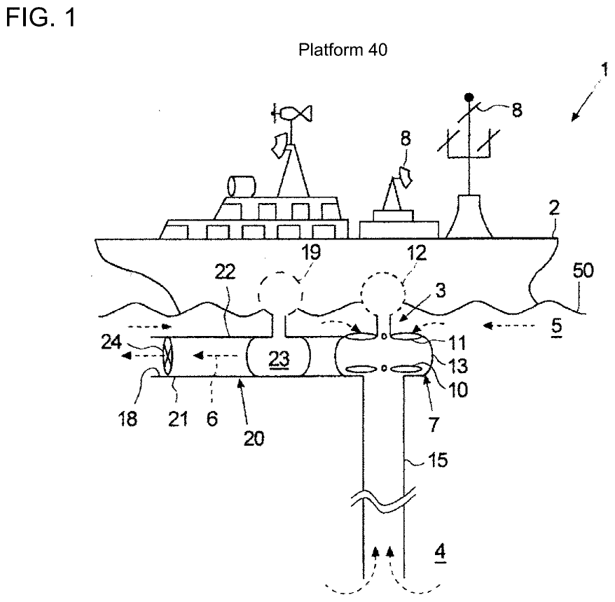

FIG. 1 is a diagram of a structure including the agitation-pumping pipe 15 for pumping the deep seawater 4. The agitation-pumping pipe 15 extends from the agitator 13 downward in the vertical direction relative to the sea surface 50.

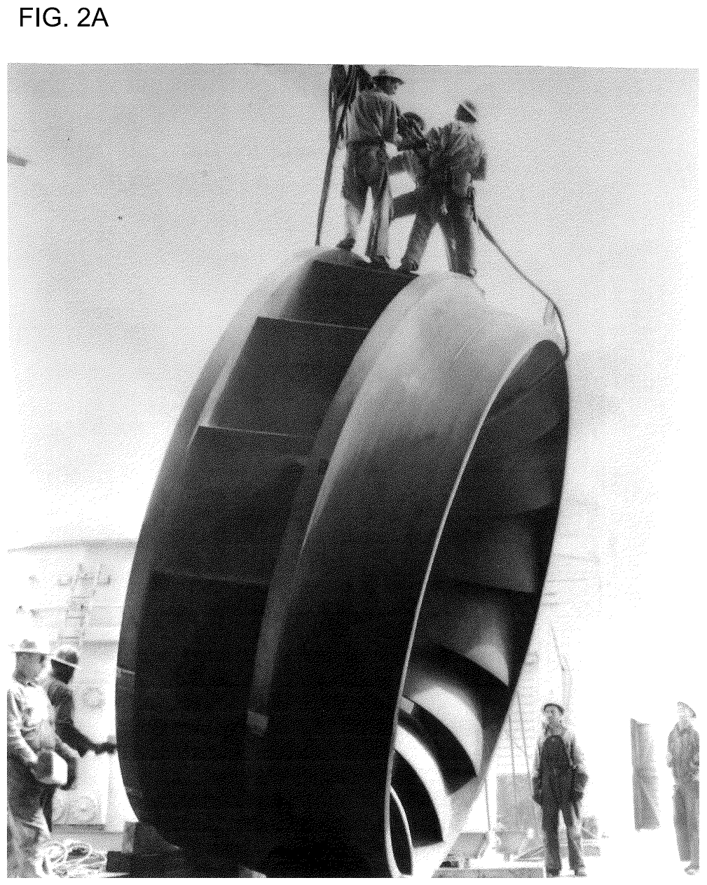

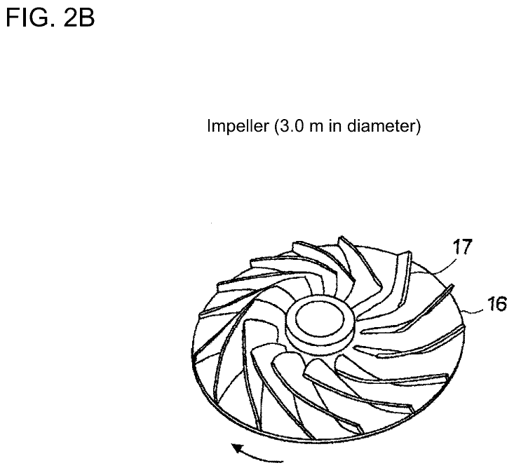

FIGS. 2A to 2B illustrate impellers usable as the pumping blades 10 or as the introduction blades 11. Each of these impellers includes a base 16 being a disk or a cone and blades 17 on the base 16 to generate a predetermined water current.

As illustrated in FIG. 1, the platform 40 includes, in its lower area, an agitated-water generator 12 including a single motor to rotate the pumping blades 10 (pumping impeller) and the introduction blades 11 (introduction impeller) or multiple motors to separately rotate these blades.

The deep seawater 4 has a heavier specific gravity than the surface water 5 and thus sinks into the deep sea after being pumped to the sea surface 50. However, the high-temperature low-density surface water 5 and the low-temperature high-density deep seawater are mixed together with the agitator 13 into the density current 6, which can thus remain close to the sea surface 50 for a long time and reduce the occurrence of a large, damaging tropical cyclone, such as a hurricane.

As will be described later, a density current is discharged from a sea area in which the Gulf Stream originates and diffuses horizontally, causing less sea-surface temperature to increase and less water vapor generation.

The structure illustrated in FIG. 1 includes a density current channel 20 connected to the agitator 13. The density current channel 20 has one end closed in the direction of a vessel, and the other end with an opening 18. The density current channel 20 includes a lower side wall 21 and an upper side wall 22 relative to the sea surface 50, and partition walls on both lateral ends as viewed in the lateral direction of the platform 40.

The partition walls allow the density current 6 to flow in the density current channel 20 separately from the surrounding surface water 5 in an area of the surface water 5 below the sea surface 50. This structure can easily maintain the temperature, density, and state of the density current 6 to be constant without being susceptible to, for example, the surrounding high-temperature surface water 5.

The structure illustrated in FIG. 1 includes a gas injector 23 for injecting gases such as oxygen. The gas injector 23 is located downstream from the agitator 13 in the density current channel 20. The gas injector 23 is used to inject a predetermined gas into the density current 6 generated by the agitator 13. Although any gas may be used, injecting oxygen may be less expensive. The base 2 includes a gas injector drive 19 to drive the gas injector 23.

The low-temperature deep seawater 4, which is denser than the surface water 5 near the sea surface 50 and can sink deep into the sea immediately after being pumped to the sea surface 50, is agitated with the surface water 5 to increase its capability of lowering the water temperature of the sea surface 50. More specifically, more gas being dissolved or more bubbles can change the overall properties or density of the generated density current 6 that thus has a smaller density difference from the surface water 5. The generated density current 6 can stay longer near the sea surface 50.

A gas injection device 31 (not illustrated) may include, as a first structure, components such as agitation blades to feed a large amount of air near the sea surface 50 into the density current channel 20. With oxygen in the air dissolving into seawater at a greater rate than nitrogen, the density current 6 contains a greater amount of dissolved oxygen. To inject air, a rotary vane is attached to a rotational shaft supported relative to the sea surface 50 near the boundary of the sea surface 50 to feed air on the sea surface 50 into the density current 6 in the density current channel 20 as the rotational shaft rotates.

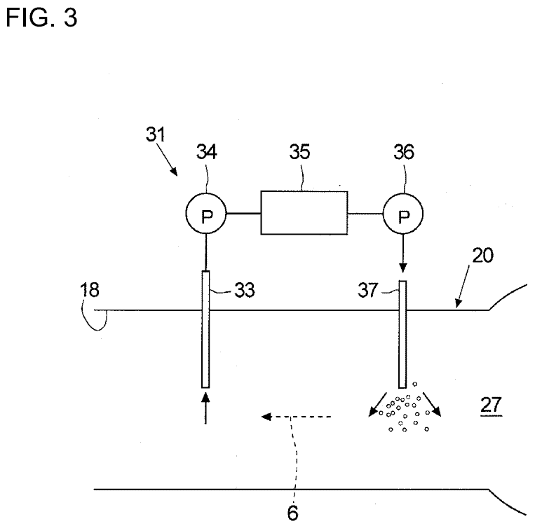

As illustrated in FIG. 3, the gas injection device 31 may include, as a second structure, an air-injection pumping pipe 33 to pump seawater in the density current channel 20, a pumping pump 34, a microbubble injector 35, an injection pump 36, and a gas injection pipe 37.

A gas injection process with the gas injection device 31 will be described later.

A gas cooler for cooling the gas fed into the density current 6 may be installed as appropriate to reduce the water temperature increase of the density current 6 in the high-temperature atmosphere.

As illustrated in FIG. 1, a discharging rotary vane 24 may be driven to actively discharge the low-temperature density current 6 to promote the discharge of the density current 6 from the density current channel 20.

The structures according to one or more embodiments of the present invention are suitable for an apparatus and a method for controlling the evaporation of water vapor in sea areas, in which hurricanes occur. The increased emissions of greenhouse gases such as carbon dioxide can destruct the ozone layer, contributing to destabilization of the atmosphere and deterioration of the global environment. To reduce and control such deterioration for humans, the marine environment is to be stabilized.

A first definition of a hurricane is a tropical cyclone that occurs in the North Atlantic Ocean east of 180 degrees west longitude, the Gulf of Mexico, or the Caribbean Sea with a maximum wind speed greater than or equal to 64 knots (33 m/s, or about 119 km/h).

A second definition of a hurricane is a tropical cyclone located in the North Atlantic, the Eastern North Pacific (east of 140 degrees west longitude in the Northern Hemisphere), the Central North Pacific (between 140 and 180 degrees west longitude in the Northern Hemisphere), or the Southeastern Pacific (east of 160 degrees east longitude in the Southern Hemisphere).

A hurricane results from water vapor generated from a sea surface. When the sea surface is heated by sunlight to higher than or equal to 80.60 degrees Fahrenheit (° F.), water vapor is generated, thus producing an updraft that then forms a spiral being a cumulonimbus cloud. This causes a disturbance, generates latent heat (melting heat), and generates more water vapor.

In other words, when the sea-surface temperature is controlled below 80.60° F., no water vapor is generated, and no updraft is produced. The occurrence of hurricanes may thus be controlled by controlling sea-surface temperatures in sea areas, in which hurricanes occur to below 80.60° F. A theory of a positive feedback process between tropical cyclone intensity and the moisture conveyor belt (TC-MCB) describes the developmental process of a tropical cyclone.

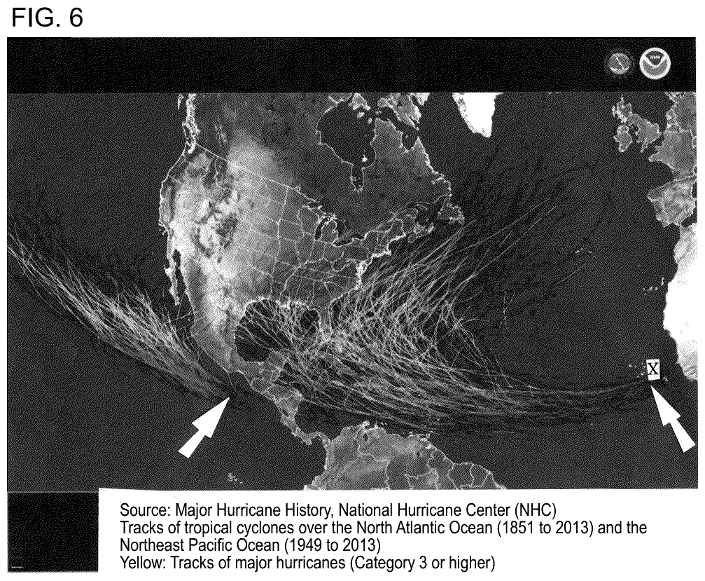

As illustrated in FIG. 6, hurricanes frequently occur in narrow areas in the northern Atlantic (including the Caribbean Sea) 200 to 300 km west of Gambia, and the Pacific Ocean 200 to 300 km west of Guatemala (with few landfalls on the mainland of the United States). A sea area X refers to a sea area, in which water vapor is most likely to be generated. The water vapor may develop into a hurricane, which may hit the mainland of the United States and cause extensive wind and flood damage. FIG. 6 illustrates hurricanes with an intensity higher than or equal to Category 3 and other tropical cyclones, illustrating their tracks. The Gulf of Mexico has a depth of 3,500 to 4,384 m. The water temperature at a depth of 200 m is about 41° F.

In FIG. 6, within a predetermined circular area with a reference position of 20°00′00″ north latitude and 13°44′31″ west longitude, discharging a generated density current into the Gulf Stream can reduce the occurrence of hurricanes that can hit the eastern coast of the United States. The predetermined circular area may have a radius of 100, 300, 600, or 900 km or greater.

Water vapor generation may be controlled by efficiently discharging a density current that is a mixture of pumped deep seawater and sea surface water into a sea area in which hurricanes occur. The generation of water vapor and the occurrence of hurricanes may be controlled efficiently by reducing water vapor generation in the two sea areas described above used as water vapor generation points, rather than the vast Atlantic Ocean being targeted.

Hurricanes can occur frequently in the five-month period from June to October. The occurrence may be controlled by controlling seawater temperatures in specific sea areas to below 80.60° F. during this period. Controlling the sea-surface temperature uses deep seawater supply and thus involves development of a deep seawater supply system through mutual cooperation with a team that operates the deep seawater pump.

The pumped deep seawater is agitated with surface water using a large agitation device to change its density into a density current. The density current can be discharged horizontally to the Gulf Stream that flows from east to west (to the mainland of the United States). The deep seawater, which cannot be a density current without agitation, can sink back into the deep sea with its specific gravity heavier than the surface water. To avoid this, the deep seawater is agitated with the surface water.

A density current is a flow phenomenon resulting from a density difference between currents of fluids or gases. With the water pressure of seawater determined by the density of its current, high-density (high-pressure) seawater flows toward low-density (low-pressure) seawater to eliminate the density and pressure differences. However, when pressures and densities of portions of seawater are substantially equal to one another, the current reaches far in a current parallel to a constant-pressure line. This horizontal movement of a density current allows discharging of the density current to the specific sea areas, in which hurricanes are likely to occur.

When the sea-surface temperature is controlled below 80.60° F. by the horizontal diffusion of the density current, the generation of water vapor and the occurrence of hurricanes can be controlled. This can protect human lives from wind and flood damage.

Agitating the density current and oxygen with an agitation device generates a dissolved-oxygen current and allows the horizontal diffusion of a dissolved-oxygen density current with a high concentration of oxygen. Oxygen dissolves into seawater more easily than nitrogen. The dissolved-oxygen current may thus easily act differently from other surface waters. Although the amount of the density current varies relative to the sea-surface temperature, the current amount is estimated to be 100,000 tons per day or 150,000 tons per day. The amount of water diffusion is to be calculated with a quantum computer.

A second embodiment of the present invention will now be described with reference to FIG. 4.

The structure according to the second embodiment includes a base 2 movable on the sea.

The base 2 may have any structure movable on the sea, but is typically a vessel.

The base 2 includes a self-positioning system such as the global positioning system (GPS) to determine the position of the base 2 and an energy source for generating energy to power the base 2 for movement, a pump 3, and an agitation device 7. When being unmanned, the base 2 includes a controller to perform predetermined processing using a device such as a communication device.

An agitator 13 in the second embodiment includes composite blades 25. The composite blades 25 (composite impeller) rotate upper introduction blades 11 and lower pumping blades 10 using a rotational shaft 28 as a part of a mixed-water generation device 12 (refer to FIG. 1).

A density current channel 20 is installed to extend in a predetermined direction relative to the vessel as the base 2.

The composite blades 25 include the introduction blades 11 to introduce seawater around the sea surface 50 into the agitator 13, the pumping blades 10 to pump the deep seawater 4 toward the sea surface 50, and the rotational shaft 28. The introduction blades 11 and the pumping blades 10 are fixed to the rotational shaft 28 to be integral with each other.

The agitator 13 includes a housing wall 26 with a shape similar to the composite impellers 25 but larger and covering the outer circumference of the composite blades 25. The housing wall 26 has a mixed current outlet 27 facing downstream and connected to the density current channel 20.

The housing wall 26 in the agitator 13 housing the composite blades 25 has a lower opening 29. The deep seawater 4 is pumped into the agitator 13 through an agitation-pumping pipe 15 as the pumping blades 10 rotate. The housing wall 26 in the agitator 13 housing the introduction blades 11 has an upper opening 30. Seawater near the sea surface 50 is drawn into the agitator 13 as the introduction blades 11 rotate.

The agitator 13 has the agitated current outlet 27 alone, from which the density current 6 flows out and flows downstream through the density current channel 20.

The structure according to the present embodiment allows a single motor 14 and the single rotational shaft 28 to pump the deep seawater 4 toward the sea surface 50 and draw the surface water 5 around the sea surface 50 into the agitator 13, thus simplifying the structure.

This compact structure also allows installation of multiple agitators 13 and multiple density current channels 20 on the vessel.

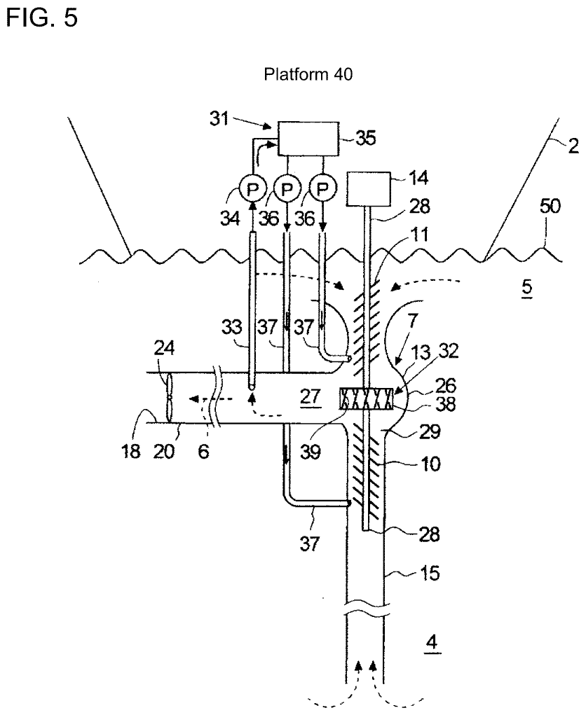

A third embodiment of the present invention will now be described with reference to FIG. 5.

The third embodiment mainly has three differences from the second embodiment as described below:

First, pumping blades 10 and introduction blades 11 used for pumping and drawing seawater are not impellers that are wide relative to a rotational shaft 28 as illustrated in FIG. 1, but are blades inclined toward the rotational shaft 28 at a predetermined angle. In one or more embodiments of the present invention, the pumping blades 10 and the introduction blades 11 may have any structures that allow pumping and drawing of seawater.

Second, when upflowing deep seawater 4 and downflowing surface water 5 from the sea surface 50 are mixed together using an agitator 13 as the pumping blades 10 and the introduction blades 11 rotate, intermediate agitation blades 32 located between the pumping blades 10 and the introduction blades 11 in the vertical direction improve the degree of mixing in the agitator 13. The intermediate agitation blades 32 may have any shape that facilitates the agitation of seawater from upward and downward. The intermediate agitation blades 32 include an annular support 38 located about the rotational shaft 28, and mixing plates 39 inclined at a predetermined angle and attached to the annular support 38.

In the second embodiment, the pumping blades 10 and the introduction blades 11 are integral with each other to agitate the deep seawater 4 and the surface water 5 sufficiently. However, the structure according to the third embodiment includes the agitator 13 including the intermediate agitation blades 32 to improve the mixing degree of low-temperature seawater and high-temperature seawater. As a result, the surface water 5 and the deep seawater 4 are agitated appropriately to improve uniformity as the density current 6.

Third, gas injection pipes 37 in a gas injection device 31 are located upstream from the seawater flow into the agitator 13 in FIG. 5.

Gas Injection Process with Gas Injection Device 31

The structure according to one or more embodiments of the present invention includes gas injection into the density current 6. The gas injection structure is located upstream or downstream from the agitator 13. A gas upstream is injected into seawater before the deep seawater 4 and surface water 5 are agitated together. A gas downstream is injected into the density current 6 generated through agitation.

The structure illustrated in FIG. 1 includes the gas injector 23 located downstream from the agitator 13 in the density current channel 20. Gas bubbles are directly injected into the agitated water 6 (density current 6) in the gas injection process.

Water with a large amount of dissolved oxygen or carbon dioxide may reportedly have properties different from water without dissolved oxygen or carbon dioxide and generate a density current and may thus be used to generate a density current.

Although air may be most conveniently used as a gas to be injected in the above embodiments, oxygen generated or stored within the base 2 alone may be injected into a density current as appropriate.

Microbubbles have a bubble diameter of 1 to 50 μm inclusive. Nanobubbles have a bubble diameter less than 1 μm. Such microbubbles and nanobubbles may reportedly have properties and behaviors largely different from normal-sized bubbles. Particularly, when being injected into water, nanobubbles may reportedly stay in the water for six months or years (e.g., two years) depending on the conditions. Microbubbles or nanobubbles may be injected into a density current. The resulting density current may have lower density at low temperatures. The density current may coexist with surface water near the sea surface and stay close to the sea surface for a long period.

When a density current with microbubbles or nanobubbles is discharged from the upstream area to the sea surface of a predetermined sea area, in which hurricanes occur, such bubbles may stay in the sea for a long period and allow the low-temperature density current to stay close to the sea surface for a long period. This can retain the sea surface at lower temperatures and reduce the occurrence of hurricanes.

To inject microbubbles or nanobubbles into the density current, the density current 6 is drawn to the vessel, receives microbubbles or nanobubbles, and is returned into the density current channel 20 as illustrated in FIG. 3. A microbubble generator is under development to discharge bubbles alone into the density current 6. Such a microbubble generator may be used once developed. Microbubbles may also be cooled to lower temperatures before being injected into the density current 6.

A sea-surface temperature lowering method according to the above embodiments generates mixed water by agitating deep seawater and surface water in the surface water, injects gas to the generated density current, and discharges the dissolved-oxygen density current into the Gulf Stream and other ocean currents around the coasts of the United States to reduce the occurrence of hurricanes that may hit the mainland of the United States.

An example method for lowering the sea-surface temperature using a sea-surface temperature lowering apparatus with the base 2, such as a vessel, as illustrated in FIG. 1 will now be described.

Process 1: When water vapor is generated in a predetermined area, in which tropical cyclones may occur (e.g., sea area X), the area and the amount of water vapor are detected with a method such as characteristic variation analysis of water vapor with the GPS, water vapor concentration measurement with a microwave radiometer usable for sea surface horizontal analysis, radiation measurement with an aircraft, or sea-surface temperature measurement with a drone.

Process 2: Information about, for example, sea-surface temperatures, ocean currents, and weather is obtained as appropriate. A cruising observation ship may assist the platform 40.

### REFERENCE SIGNS LIST

1 sea-surface temperature lowering apparatus
2 base (example of platform)
3 pump
4 deep seawater
5 surface water
6 agitated water (dissolved-oxygen density current)
7 agitation device
8 communication device
10 pumping blade
11 introduction blade
12 agitated-water generator
13 agitator
14 motor
15 agitation-pumping pipe
18 opening
19 gas injector drive
20 density current channel
21 lower side wall
22 upper side wall
23 gas injector
24 discharging rotary vane
25 composite blade
26 housing wall
27 mixed current outlet
28 rotational shaft
29 lower opening
30 upper opening
31 gas injection device
32 intermediate agitation blades
33 air-injection pumping pipe
34 pumping pump
35 microbubble injector
36 injection pump
37 gas injection pipe
38 annular support
39 mixing plates
40 platform
50 sea surface

What is claimed is:

1. A sea-surface temperature lowering apparatus, comprising:
a pump configured to pump deep seawater;
an agitation device configured to agitate the pumped deep seawater and surface water to generate mixed water being a density current; and
a platform including the pump and the agitation device,
wherein the generated density current is discharged toward an ocean current flowing around United States coasts to reduce a hurricane on the East Coast of the United States.

2. The sea-surface temperature lowering apparatus according to claim 1, further comprising:
a gas injection device configured to inject a gas into the mixed water.

3. The sea-surface temperature lowering apparatus according to claim 2, wherein
the gas injection device injects the gas into the density current to generate a dissolved-oxygen density current with a higher concentration of oxygen, the platform is within a predetermined circular area including a position of 20°00′00″ north latitude and 13°44′31″ west longitude, and the dissolved-oxygen density current is discharged to join the Gulf Stream.

4. The sea-surface temperature lowering apparatus according to claim 2, wherein
the gas injection device is located downstream in the density current from an agitator included in the agitation device.

5. The sea-surface temperature lowering apparatus according to claim 4, wherein
the platform includes a density current channel, in which the density current flows, and the agitator is located upstream from the gas injection device in the density current channel.

6. The sea-surface temperature lowering apparatus according to claim 2, wherein
the gas injection device injects the gas into seawater in an agitator included in the gas injection device or seawater flowing into the agitator.

7. The sea-surface temperature lowering apparatus according to claim 2, wherein
the gas injected into the mixed water includes microbubbles with a diameter of 1 to 50 μm inclusive, or nanobubbles with a diameter less than 1 μm.

8. The sea-surface temperature lowering apparatus according to claim 1, further comprising:
composite blades including pumping blades in the pump and introduction blades in the agitation device,
wherein the pumping blades and the introduction blades are integral with each other, and
wherein the composite blades are fixed to a single rotational shaft.

9. A sea-surface temperature lowering method, comprising:
generating mixed water being a density current by agitating deep seawater pumped and surface water in the surface water; and
discharging the generated density current toward an ocean current flowing around the East Coast of the United States to reduce a hurricane on a mainland of the United States.

10. The sea-surface temperature lowering method according to claim 9, wherein
the discharging the generated density current includes discharging the generated density current from a predetermined circular area including a position with coordinates of 20°00′00″ north latitude and 13° 44′31″ west longitude toward the Gulf Stream to reduce a hurricane on the mainland of the United States.

11. The sea-surface temperature lowering method according to claim 9, further comprising:
injecting a gas into the mixed water.

12. The sea-surface temperature lowering method according to claim 11, wherein
the injecting the gas includes injecting the gas into seawater before the deep seawater and the surface water are agitated.

13. The sea-surface temperature lowering method according to claim 11, wherein
the injecting the gas includes injecting the gas into the density current after the deep seawater and the surface water are agitated.

14. The sea-surface temperature lowering method according to claim 9, wherein
a platform is assisted by a cruising observation ship.
